(19) United States
(12) Patent Application Publication
(10) Pub. No.: US 2009/0205892 A1
(43) Pub. Date: Aug. 20, 2009

(54) Hydraulic hybrid powertrain with exhaust-heated accumulator

(75) Inventors: Jeffrey Edward Jensen, Dunlap, IL (US); Evan Lee Foster, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/071,225

(22) Filed: Feb. 19, 2008

(51) Int. Cl. B60K 6/22

(52) U.S. Cl. 180/165; 903/904

(57) ABSTRACT

A hydraulic hybrid powertrain is provided. The hydraulic hybrid powertrain has an engine. The hydraulic hybrid powertrain also has at least one pump/motor assembly operatively associated with the engine. The hydraulic hybrid powertrain further has an accumulator fluidly coupled to the at least one pump/motor assembly. The hydraulic hybrid powertrain further still has a reservoir fluidly coupled to the at least one pump/motor assembly. The hydraulic hybrid powertrain also has a heat exchanger associated with the accumulator and the heat exchanger is configured to receive exhaust from the engine.

### TECHNICAL FIELD

The present disclosure relates generally to a hydraulic hybrid powertrain and, more particularly, to a hydraulic hybrid powertrain with an exhaust-heated accumulator.

### BACKGROUND

The growing utilization of automobiles and other mobile machines with internal combustion engines greatly increases global fuel consumption. Current powertrains typically average less than 50% thermal efficiency. Accordingly, new approaches are needed to improve the efficiency of fuel utilization for powertrains and to reduce wasted energy associated with exhaust emissions.

Conventional vehicle and machine powertrains result in significant energy loss, make it difficult to effectively control energy associated with exhaust emissions, and offer limited potential for improvements in fuel economy. Conventional powertrains include an internal combustion engine and a mechanical transmission having a discrete number of gear ratios. Approximately 75% to 90% of the fuel energy consumed by such a system is wasted as heat in braking, internal friction in the engine, drivetrain or geartrain losses, and in exhaust emitted from an engine of the powertrain.

Hybrid powertrains have been developed to mitigate the above-described inefficiencies. Hybrid powertrains include electric hybrid systems and hydraulic hybrid systems. Hybrid powertrains may be employed in conventional automotive vehicles and on-highway trucks, as well as in various other machines, including construction machines such as hydraulic excavators, off-highway trucks, etc.

One attempt to resolve the energy loss associated with exhaust emission is described in U.S. Pat. No. 5,121,607 (the '607 patent) issued to George, Jr. on Jun. 16, 1992. The '607 patent discloses an energy recovery system for a vehicle with an internal combustion engine. The recovery system of the '607 patent utilizes a Rankine cycle with a working fluid and braking energy to recover the heat loss of the exhaust gases by compressing and expanding the working fluid. A heat exchanger such as a boiler, a boiler drum, and a flash chamber are connected into the system in order to transfer the heat from the exhaust gases.

Although the recovery system of the '607 patent may improve over previous Rankine cycle systems, it may be costly. For example, the inclusion of the heat exchanger, the boiler drum and the flash chamber increase weight and volume of the powertrain. The inclusion of these components also adds to the cost and weight of the vehicle.

The present disclosure is directed to one or more improvements in the existing technology.

### SUMMARY

In one aspect, the present disclosure is directed to a hydraulic hybrid powertrain. The hydraulic hybrid powertrain may include an engine. The hydraulic hybrid powertrain may also include at least one pump/motor assembly operatively associated with the engine. The hydraulic hybrid powertrain may further include an accumulator fluidly coupled to the at least one pump/motor assembly. The hydraulic hybrid powertrain may further still include a reservoir fluidly coupled to the at least one pump/motor assembly. The hydraulic hybrid powertrain may also include a heat exchanger associated with the accumulator, and the heat exchanger may be configured to receive exhaust from the engine.

In another aspect, the present disclosure is directed to a method of recovering energy in a hydraulic hybrid powertrain. The method may include operating an engine and an associated pump/motor assembly. The method may also include alternately directing fluid between a reservoir and an accumulator with the pump/motor assembly. The method may further include heating the fluid in the accumulator by directing exhaust from the engine to a heat exchanger associated with the accumulator.

### BRIEF DESCRIPTION OF THE DRAWINGS

FIG. 1 is a diagrammatic illustration of an exemplary parallel hybrid powertrain consistent with the present disclosure;

FIG. 2 is a diagrammatic illustration of an exemplary series hybrid powertrain consistent with the present disclosure; and

FIG. 3 is a diagrammatic illustration of an exemplary control system for use with either of the powertrains in FIGS. 1 and 2.

### DETAILED DESCRIPTION

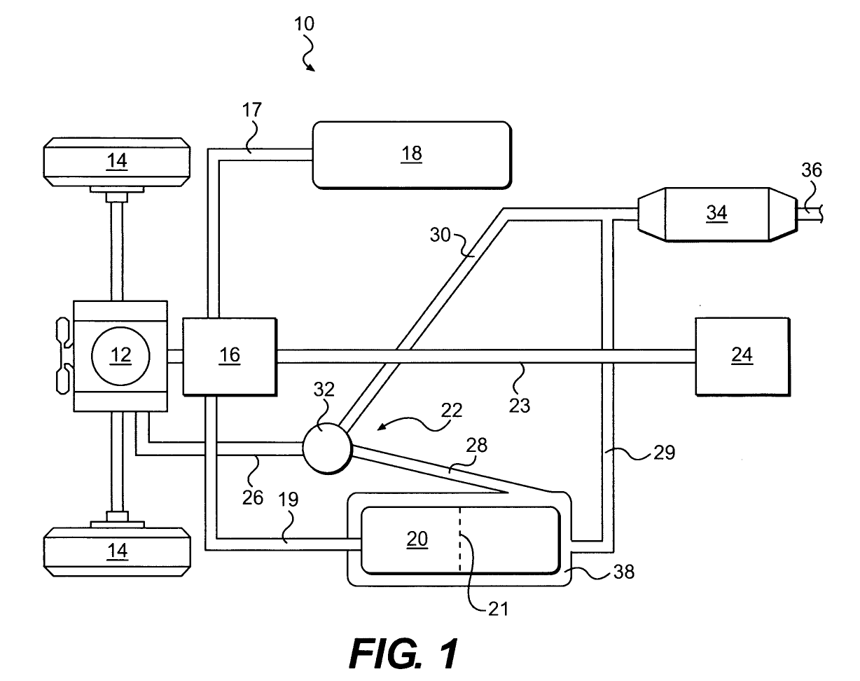

FIG. 1 illustrates an exemplary parallel hydraulic hybrid powertrain 10. Powertrain 10 may be associated with any machine where the use of powertrain 10 may be appropriate. Powertrain 10 may include a power source 12, at least one output component, such as a driven ground engaging element, and a pump/motor assembly 16. In FIG. 1, the output component is illustrated as ground engaging elements in the form of wheels 14. It will be understood that other forms of ground engaging elements, e.g., tracks, are contemplated. Power source 12 may be operatively associated with wheels 14 and pump/motor assembly 16. Power source 12 may produce a power output and may include an internal combustion engine such as, for example, a diesel engine, a gasoline engine, a gaseous fuel powered engine, or any other engine apparent to one skilled in the art.

As illustrated in FIG. 1, powertrain 10 may include a low pressure reservoir 18 and a high pressure accumulator 20. Low pressure reservoir 18 may be a tank, for example, configured to hold a supply of fluid. The fluid may include, for example, a hydraulic oil, an engine lubrication oil, a transmission lubrication oil, or any other fluid known in the art. Pump/motor assembly 16 may operate as a pump to draw fluid from low pressure reservoir 18 when pump/motor assembly 16 is driven by power source 12, for example. Low pressure reservoir 18 may be fluidly coupled to pump/motor assembly 16 via passageway 17.

High pressure accumulator 20 may embody a pressure vessel fluidly coupled to pump/motor assembly 16 via passageway 19. High pressure accumulator 20 may be filled with a compressible gas and configured to store pressurized fluid for future use as a source of fluid power. The compressible gas may include, for example, nitrogen or another appropriate compressible gas. As fluid in communication with high pressure accumulator 20 exceeds a predetermined pressure, for example when pump/motor assembly 16 is operating as a pump, fluid may flow into high pressure accumulator 20. Because the nitrogen gas is compressible, it may be compressed as the fluid flows into high pressure accumulator 20. As illustrated in FIG. 1, high pressure accumulator 20 may include two compartments, divided by a movable or flexible divider 21, a piston for example, for storing the compressible gas and the pressurized fluid separately.

When the pressure of the fluid within passageways communicating with high pressure accumulator 20 drops below a predetermined pressure, the compressed nitrogen within high pressure accumulator 20 may expand and urge the fluid within high pressure accumulator 20 to exit into passageway 19. Pump/motor assembly 16 may then operate as a motor, delivering energy to powertrain 10. It is contemplated that high pressure accumulator 20 may alternatively embody a spring biased or other type of accumulator. Powertrain 10 may also include a diagrammatically illustrated axle assembly 24, or other type of driven power delivery assembly, coupled to pump/motor assembly 16 via at least one diagrammatically illustrated output component 23. Output component 23 may be a torque transfer component such as a drive shaft. Axle assembly 24 may be operatively associated to another set of wheels or other ground engaging elements (not shown). It is contemplated that axle assembly 24 may include a second pump/motor assembly fluidly coupled to pump/motor 16, if desired.

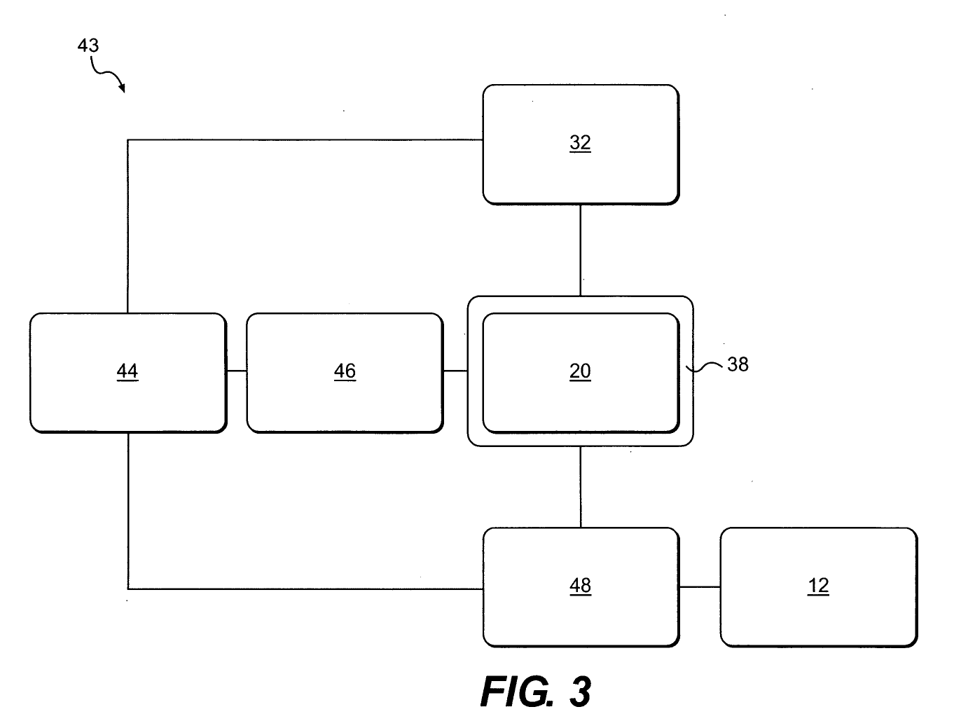

Powertrain 10 may further include an exhaust system 22. Exhaust system 22 may include exhaust passageways 26, 28, 29, 30, and 36, a control valve 32, and a muffler 34. A heat exchanger 38 may be associated with high pressure accumulator 20 and in communication with exhaust system 22. While heat exchanger 38 is illustrated to enclose high pressure accumulator 20, it is contemplated that exhaust may be directed over high pressure accumulator 20 without an enclosed heat exchanger. Referring to FIG. 3, control valve 32 may be associated with a controller 44 configured to operate control valve 32. As illustrated diagrammatically in FIG. 1, control valve 32, for example. Power source 12 may emit exhaust, and exhaust may enter exhaust passageway 26. Exhaust may then partially enter exhaust passageways 28 and 30 at a suitable setting of control valve 32.

Control valve 32 may be operated to direct exhaust to enter exhaust passageway 30 and thereby inhibit exhaust from entering exhaust passageway 28. For example, control valve 32 may permit exhaust within exhaust passageway 26 to enter exhaust passageway 30, flow through a muffler 34, and exit exhaust system 22 via exhaust passageway 36. On the other hand, control valve 32 may be operated to selectively direct exhaust within exhaust passageway 26 to enter exhaust passageway 28 and be received by heat exchanger 38. Control valve 32 may be operated to selectively direct exhaust within exhaust passageway 26 to partially enter exhaust passageways 28 and 30. Exhaust within heat exchanger 38 may serve to heat up the compressible gas within high pressure accumulator 20. Exhaust within heat exchanger 38 may also serve to heat up the pressurized fluid within high pressure accumulator 20. Exhaust within heat exchanger 38 may exit heat exchanger 38 via exhaust passageway 29 and enter exhaust passageway 30.

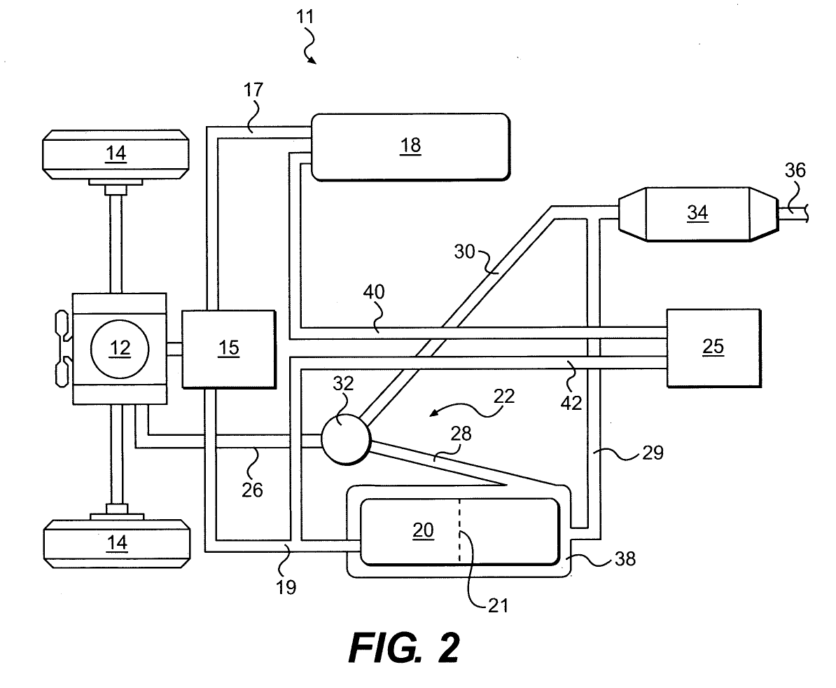

FIG. 2 illustrates an exemplary series hydraulic hybrid powertrain 11, and illustrates components in common with powertrain 10 of FIG. 1. The same reference numerals will be used throughout the drawings to refer to the same or like parts that are common to both powertrains 10 and 11. While powertrains 10 and 11 may include some components in common, powertrains 10 and 11 may include some components that are different. For example, powertrain 11 may include a pump/motor assembly 25, while powertrain 10 may include axle assembly 24 without a pump/motor unit. Powertrain 11 may include passageway 40 which may communicate pump/motor assembly 25 with low pressure reservoir 18. Powertrain 11 may also include passageway 42 which may communicate pump/motor assembly 25 with passageway 19.

Powertrain 11 may include a pump 15 operatively associated with power source 12. Pump 15 may operate to draw fluid from low pressure reservoir 18 when pump 15 is driven by power source 12, for example. Pump 15 may also operate to deliver fluid to high pressure accumulator 20. When the pressure of the fluid within passageways communicating with high pressure accumulator 20 drops below a predetermined pressure, the compressed nitrogen within high pressure accumulator 20 may expand and urge the fluid from within high pressure accumulator 20 to exit into passageway 19 and subsequently enter passageway 42, and pump/motor assembly 25 may then operate as a motor, delivering energy to powertrain 11. Pump/motor assembly 25 may also operate as a pump to draw fluid from low pressure reservoir 18. It is contemplated that a control valve (not shown) may be included and may be located at a juncture of passageways 19 and 42. The control valve may be operated to retain the fluid within high pressure accumulator 20 and thereby maintain the pressure within high pressure accumulator 20. It is also contemplated that pump 15 may include a second pump/motor assembly operatively associated with power source 12, if desired.

FIG. 3 diagrammatically illustrates an exhaust control circuit 43 that may be associated with exhaust system 22 by way of control valve 32. Exhaust control circuit 43 may include controller 44, a sensor 46, and a cooling component 48. Controller 44 may communicate with control valve 32, sensor 46, and cooling component 48, for example, via communication lines diagrammatically illustrated. Controller 44 may operate control valve 32 and/or cooling component 48 in response to a predetermined parameter associated with high pressure accumulator 20 which may be sensed by sensor 46. Cooling component 48 may be utilized to extract heat from heat exchanger 38. Cooling component 48 may include a cooling fan, an engine jacket water cooling system, etc. Cooling component 48 may also be associated with power source 12 and may be configured to extract heat from power source 12.

Sensor 46 may be associated with controller 44 and high pressure accumulator 20, and may be configured to sense the predetermined parameter associated with high pressure accumulator 20. Sensor 46 may deliver a signal to controller 44 indicative of the predetermined parameter sensed by sensor 46. Controller 44 may be configured to operate control valve 32 and/or cooling component 48 in response to the signal. In one embodiment, sensor 46 may be a volume sensor configured to sense a volume of fluid within high pressure accumulator 20. In another embodiment, sensor 46 may be a temperature sensor configured to sense a temperature within high pressure accumulator 20. In a third embodiment, sensor 46 may be a pressure sensor configured to sense a pressure within high pressure accumulator 20. In a fourth embodiment, sensor 46 may be a viscosity sensor configured to sense a viscosity of the fluid within high pressure accumulator 20. It is contemplated that sensor 46 may be any appropriate type of sensor used for sensing a suitable predetermined parameter associated with high pressure accumulator 20. It is also contemplated that sensor 46 may include one or more sensors.

For example, when a volume sensor is employed as sensor 46, controller 44 may be configured to alternately move control valve 32 to direct exhaust to enter heat exchanger 38 and to activate cooling component 48 to extract heat from heat exchanger 38 in response to the volume of fluid within high pressure accumulator 20 sensed by sensor 46. When the volume of fluid within high pressure accumulator 20 increases, indicating that fluid may be flowing into high pressure accumulator 20, or when the volume of fluid within high pressure accumulator 20 is at its maximum, indicating that high pressure accumulator 20 may be filled with fluid, exhaust may be directed to enter heat exchanger 38. When the volume of fluid within high pressure accumulator 20 decreases, indicating that fluid may be flowing from high pressure accumulator 20, or when the volume of fluid within high pressure accumulator 20 is at its minimum, indicating that high pressure accumulator 20 may be empty, exhaust may be inhibited from entering heat exchanger 38 and cooling component 48 may be operated to extract heat from heat exchanger 38.

### INDUSTRIAL APPLICABILITY

The disclosed hydraulic hybrid powertrains may be applicable to any machine operation where efficiency is important. By implementing the disclosed embodiments, efficiency may be increased both by reducing fuel consumption by power source 12 in the hydraulic hybrid powertrains, and by recovering and using exhaust heat energy that would otherwise be lost.

Referring to FIG. 1, when powertrain 10 is in operation, exhaust may be emitted from power source 12 via exhaust passageway 26. Emission of exhaust may be a major source of wasted heat energy. In a powertrain without the ability to recover the heat loss during exhaust, the heat energy associated with the exhaust would be lost. The inclusion of exhaust passageway 28 may allow exhaust to be received by heat exchanger 38 associated with high pressure accumulator 20. Because heat exchanger 38 is capable of receiving exhaust from power source 12, energy wasted by the emission of exhaust is reduced. The recovery of heat to high pressure accumulator 20 may increase energy storage. It may also allow powertrain 10 to use more energy to drive hydraulic components and use power source 12 less. By using power source 12 less, fuel consumption and energy loss due to exhaust emitted from power source 12 may also be reduced.

Referring to FIG. 3, exhaust control circuit 43 may be employed to control heat energy. For example, exhaust control circuit 43 may include controller 44, sensor 46 and cooling component 48. In one embodiment, sensor 46 may be a volume sensor configured to sense a volume of fluid within high pressure accumulator 20. Controller 44 may operate control valve 32 to allow exhaust to enter heat exchanger 38 when the volume of fluid within high pressure accumulator 20 is increasing or is at its maximum. In other words, high pressure accumulator 20 may be heated when it is filling up or already filled. On the other hand, controller 44 may operate cooling component 48 to extract heat from high pressure accumulator 20 when the volume of fluid within high pressure accumulator 20 is decreasing or is at its minimum. In other words, high pressure accumulator 20 may be cooled when it is draining or already drained. Exhaust control circuit 43 may maintain and maximize the pressure inside high pressure accumulator 20, may increase the amount of energy that is usable downstream of high pressure accumulator 20, may increase the efficiency of high pressure accumulator 20, and may increase the efficiency of the hydraulic components downstream of high pressure accumulator 20.

Because controller 44 and control valve 32 may direct exhaust to enter exhaust passageway 30, the risk of too much heat being built up within high pressure accumulator 20 may be minimal. The inclusion of exhaust passageway 29 may also help to reduce the risk of too much heat being built up within high pressure accumulator 20. For example, exhaust may enter heat exchanger 38 via exhaust passageway 28 and exit heat exchanger 38 via exhaust passageway 29. Thus, exhaust may not be retained in heat exchanger 38 for a prolong period of time. The use of controller 44 to operate cooling component 48 may further help to reduce the risk of too much heat being built up within high pressure accumulator 20. For example, sensor 46 may be a temperature sensor configured to sense a temperature within high pressure accumulator 20. Controller 44 may operate control valve 32 to permit exhaust to enter exhaust passageway 30 and thereby inhibit exhaust from entering heat exchanger 38, in response to the temperature within high pressure accumulator 20 sensed by sensor 46. Controller 44 may also operate cooling component 48 to extract heat from heat exchanger 38 in response to the temperature within high pressure accumulator 20 sensed by sensor 46.

It will be apparent to those skilled in the art that various modifications and variations can be made to the hydraulic hybrid powertrain of the present disclosure. Other embodiments of the hydraulic hybrid powertrain will be apparent to those skilled in the art from consideration of the specification and practice of the invention disclosed herein. It is intended that the specification and examples be considered as exemplary only, with a true scope of the invention being indicated by the following claims.

What is claimed is:

1. A hydraulic hybrid powertrain, comprising:
an engine;
at least one pump/motor assembly operatively associated with the engine;
an accumulator fluidly coupled to the at least one pump/motor assembly;
a reservoir fluidly coupled to the at least one pump/motor assembly; and
a heat exchanger associated with the accumulator, the heat exchanger being configured to receive exhaust from the engine.

2. The hydraulic hybrid powertrain of claim 1, wherein the at least one pump/motor assembly includes two pump/motors.

3. The hydraulic hybrid powertrain of claim 2, wherein both pump/motors are fluidly coupled to the accumulator and the reservoir.

4. The hydraulic hybrid powertrain of claim 1, further including an exhaust system associated with the engine, the exhaust system being configured to receive exhaust from the engine and direct exhaust to the atmosphere.

5. The hydraulic hybrid powertrain of claim 1, further including
a control valve configured to selectively permit exhaust to be directed to the heat exchanger; and
a controller configured to operate the control valve.

6. The hydraulic hybrid powertrain of claim 5, further including a cooling component associated with the accumulator.

7. The hydraulic hybrid powertrain of claim 6, further including a sensor configured to sense a predetermined parameter associated with the accumulator and deliver a signal to the controller indicative of the predetermined parameter sensed by the sensor, and wherein the controller is configured to operate at least one of the control valve and the cooling component in response to the signal.

8. The hydraulic hybrid powertrain of claim 7, wherein the sensor is configured to sense at least one of a volume, a temperature, a pressure, and a viscosity of a fluid associated with an accumulator.

9. The hydraulic hybrid powertrain of claim 5, wherein the controller is configured to alternately and selectively operate the control valve to direct exhaust to the heat exchanger and operate a cooling component to extract heat from the heat exchanger.

10. A method of recovering energy in a hydraulic hybrid powertrain, comprising:
operating an engine and an associated pump/motor assembly;
alternately directing fluid between a reservoir and an accumulator with the pump/motor assembly; and
heating the fluid in the accumulator by directing exhaust from the engine to a heat exchanger associated with the accumulator.

11. The method of claim 10, further including
associating a cooling component with the heat exchanger; and
selectively operating the cooling component to cool the heat exchanger.

12. The method of claim 11, further including
sensing a predetermined parameter associated with the heat exchanger; and
selectively directing exhaust to the heat exchanger in response to the sensed predetermined parameter.

13. The method of claim 11, further including
sensing a predetermined parameter associated with the heat exchanger; and
alternately directing exhaust to the heat exchanger and operating the cooling component in response to the sensed predetermined parameter.

14. A machine, comprising:
an engine;
at least one pump/motor assembly operatively connected to the engine;
an accumulator fluidly coupled to the at least one pump/motor assembly;
a reservoir fluidly coupled to the at least one pump/motor assembly;
a heat exchanger associated with the accumulator, the heat exchanger being configured to partially receive exhaust from the engine; and
an output component operatively associated with at least one of the engine and the at least one pump/motor assembly.

15. The machine of claim 14, wherein the at least one pump/motor assembly includes two pump/motors.

16. The machine of claim 15, wherein both pump/motors are fluidly coupled to the accumulator and the reservoir.

17. The machine of claim 14, further including an exhaust system associated with the engine, the exhaust system being configured to receive exhaust from the engine and direct exhaust to the atmosphere.

18. The machine of claim 14, further including
a control valve configured to selectively direct exhaust to the heat exchanger;
a cooling component associated with the accumulator;
a sensor configured to sense a predetermined parameter associated with the accumulator; and
a controller configured to operate the control valve and the cooling component.

19. The machine of claim 18, wherein the controller is configured to alternately operate the control valve to direct exhaust to the heat exchanger and operate the cooling component to extract heat from the heat exchanger in response to the predetermined parameter associated with the accumulator sensed by the sensor.

20. The machine of claim 18, wherein the sensor is configured to sense at least one of a volume, a temperature, a pressure, and a viscosity of a fluid associated with the accumulator.
